(19) United States
(12) Patent Application Publication
(10) Pub. No.: US 2016/0036137 A1
(43) Pub. Date: Feb. 4, 2016

(54) CLIP OF CONNECTING WIRE

(71) Applicant: PREMIER MERCHANDISES LIMITED, Hong Kong (HK)

(72) Inventor: Alberto Magno Aponte, Hong Kong (HK)

(73) Assignee: PREMIER MERCHANDISES LIMITED, Hong Kong (HK)

(21) Appl. No.: 14/711,795

(22) Filed: May 14, 2015

(30) Foreign Application Priority Data
Jul. 30, 2014 (HK) 14107746.6

(51) Int. Cl. H01R 4/48; H01R 11/22; H01R 4/50

(52) U.S. Cl. CPC H01R 4/48; H01R 4/50; H01R 11/22

(57) ABSTRACT

A clip of connecting wire includes a first metal arm, a second metal arm hinged with the first metal arm, and an elastic member arranged on a hinged portion of the first metal arm and the second metal arm is provided. The first metal arm and the second metal arm define a hinged hole. A sleeve is provided in the hinging hole for connecting the first metal arm, the second metal arm and the elastic member. The sleeve defines a smooth through hole therein. A fixing device extends through the through hole, and includes a first connecting member extending through the through hole, a second connecting member screwed on the first connecting member, and a disassembly member provided on one of the first connecting member and the second connecting member. A movable terminal is formed between the first connecting member and the second terminal for connecting the clip.

### CROSS-REFERENCE TO RELATED APPLICATIONS

This application claims the benefit of Hong Kong short-term patent application No. 14107746.6 filed on Jul. 30, 2014; the contents of which is hereby incorporated by reference.

### TECHNICAL FIELD

The present invention relates to a field of charging equipments, particularly to a clip of connecting wire for interconnecting charger and storage battery.

### BACKGROUND

Clip of connecting wire is a device for connecting charger and storage battery, which can be used for charging storage batteries of cars, motors, motorcycles, or other household equipments. As shown in FIG. 1, a conventional method is solder terminal 130 to the clip 100, thus the clip 100 and the terminal 130 are integral. The terminal 130 is connected to the charger 200, and the clip 100 clasps on the storage battery 300 of the car, motor, or motorcycle. The conventional clip 100 results in that each charger 200 has one clip 100, and thus can only charge one type of matching storage battery 300. During working, the clip 100 clasps on the storage battery 300 and the charger 200 charges the storage battery 300.

Two ways to modify the conventional technology are follows: one is adding an adapter 400 between the charger 200 and the clip 100 of connecting wire (as shown in FIG. 1), i.e., a first adapter 400 is mounted on an outputting wire of the charger 200, and two or more conventional clips 100 are connected to a second adapter 400, the first adapter 400 and the second adapter 400 are matched with each other. In use, the first adapter 400 is connected to the second adapter 400, thus makes the charger 200 can be used to charge several types of storage batteries. The method of adding adapter 400 makes the charger 200 can connect several clips 100, and thus can charge several types of storage batteries, but this method needs to connect two or more conventional clips 100 to one adapter 400, adding adapter 400 and its manufacturing process cost. The other way is using ordinary screw 150 to assemble/disassemble the terminal 130 of the charger 200 to/from different types of clips 100 (as shown in FIG. 2), thus the charger 200 can be used to charge different types of storage batteries, which is more convenient for people's life. The method of using ordinary screw 150 to assemble or disassemble needs to form internal threads matching external threads of the ordinary screw 150 in hinged portions of different types of clips 100. In use, the internal threads in the hinged portion are excessive wear, and thus needs to replace the clip 100. Furthermore, using the ordinary screw 150 to assemble or disassemble the terminal 130 and clip 100 needs auxiliary tools (such as a screw 150 driver), which is inconvenient.

### SUMMARY

The technical problem of the present invention needs to be solved is providing a clip of connecting wire for overcoming the defects in prior arts.

A solution to solve the technical problem of the present invention is:

A clip of connecting wire includes a first metal arm, a second metal arm hinged with the first metal arm, and an elastic member arranged on a hinged portion of the first metal arm and the second metal arm is provided. The first metal arm and the second metal arm define a hinged hole. A sleeve is provided in the hinging hole for connecting the first metal arm, the second metal arm and the elastic member. The sleeve defines a smooth through hole therein. A fixing device extends through the through hole, and includes a first connecting member extending through the through hole, a second connecting member screwed on the first connecting member, and a disassembly member provided on one of the first connecting member and the second connecting member. A movable terminal is formed between the first connecting member and the second terminal for connecting the clip.

Further, the first connecting member comprises a connecting part extending through the through hole, a locking part integrally formed with the connecting part, and a disassembling rod mounted on the locking part offsetly for assembling or disassembling the terminal and the clip, an end of the connecting part away from the locking part forming external threads matching with the second connecting member, an external diameter of the locking part being larger than a diameter of the through hole.

Further, the disassembly rod comprises an offsetting pivot fixed on the locking part and an arc-shaped handle integrally formed with the offsetting pivot, when the handle is pull up, the terminal and the clip are unfix, and when the handle is press down, the terminal and the clip are fixed, and a distance of a portion of the offsetting pivot between the locking part and the terminal in the state of unfix is less than that of a potion of the offsetting pivot between the locking part and the terminal in the fixed state.

Further, the disassembly member comprises two disassembly wings integrally formed with the second connecting member.

Further, the terminal is arranged on the connecting part between the disassembly rod and the sleeve, and a gasket is mounted on the connecting part between the terminal and the disassembly rod.

Further, the first connecting member comprises a connecting part and a locking part integrally formed with the connecting part, an end of the connecting part away from the locking part forming external threads matching with the second connecting member.

Further, the terminal is arranged on the connecting part between the locking part rod and the sleeve or is arranged on the connecting part between the second connecting member and the sleeve, and a gasket is mounted on the connecting part between the terminal and the locking part or between the terminal and the second connecting member.

Further, the disassembly member comprises two disassembly wings integrally formed with the first connecting member and opposite to each other.

Further, the disassembly member comprises two disassembly wings integrally formed with the second connecting member and opposite to each other, and the locking part defines a recess having one of shapes of “+”, “−” and “*”.

Further, the sleeve comprises a first sleeve element and a second sleeve element corresponding to the first sleeve element, the first sleeve element comprising a first ring and a first cylinder perpendicular to the first ring and integrally formed with the first ring, the second sleeve element comprising a second ring and a second cylinder perpendicular to the second ring and integrally formed with the second ring, an inner diameter of the first cylinder being larger than that of the second cylinder, the second cylinder defining the through hole.

Compared with the prior arts, the clip of the present invention has advantages as follows: the hinged hole between the first metal arm and the second metal arm is provide with a sleeve defining smooth through hole and a fixing device extending through the through hole, which can avoid wear of internal of the clip and frequently replacing of the clip in the way of using ordinary screw to assembly or disassembly the terminal and the clip, which is in favor of saving costs of charging of the storage batteries of the household equipments. The fixing device includes a first connecting member extending through the through hole, and a second connecting member corresponding to the first connecting member which makes assembly or disassembly of the terminal and the clip need not auxiliary tools, thus more convenient in use. The movable terminal is formed between the first connecting member and the second terminal for connecting the clip, which makes the terminal can be used to connect different types of clips, thereby charging different types of storage batteries, thus charging of the storage battery is convenient, and needs not dedicated clip or terminal.

### BRIEF DESCRIPTION OF THE DRAWINGS

The present invention will be described in detail with reference to the drawings and embodiments. In the drawings:

FIG. 1 is a schematic view of a conventional technology with adapter between the charger and storage battery.

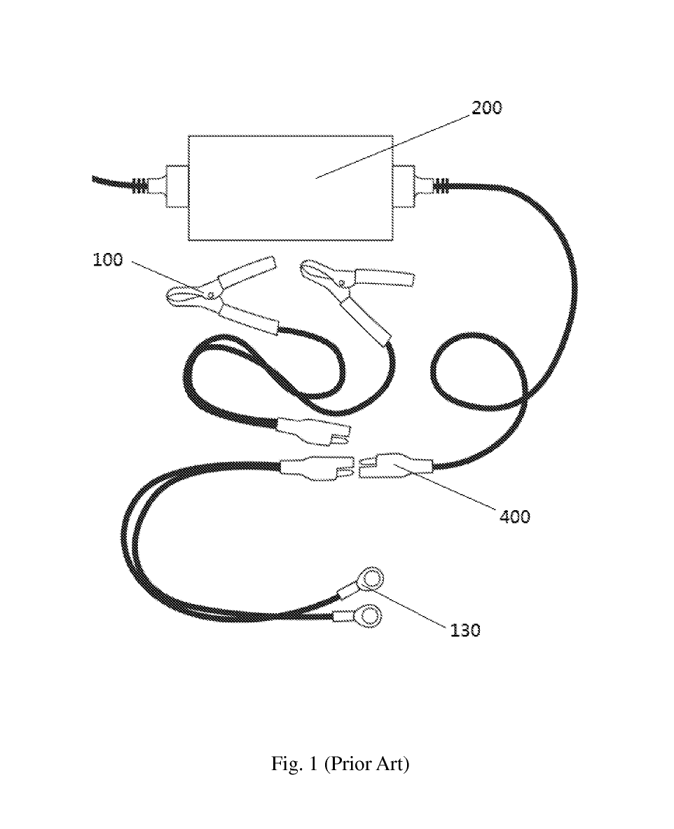

FIG. 2 is a schematic view of a conventional technology with ordinary screw fixing the terminal and the clip.

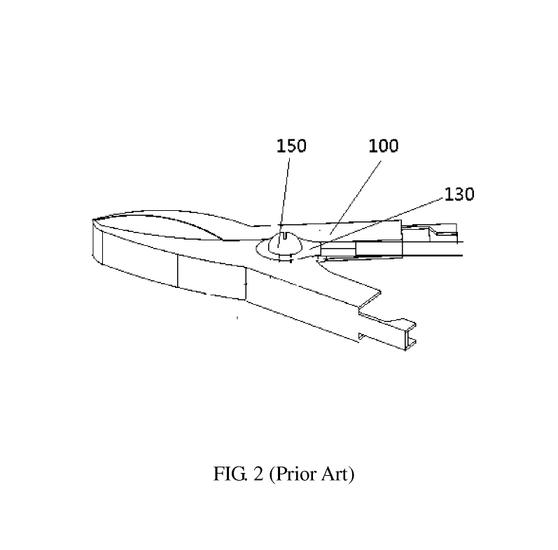

FIG. 3 is a schematic view of a clip of connecting wire according to a first embodiment.

FIG. 4 is a schematic view showing part of the clip of the first embodiment.

FIG. 5 is an exploded view of FIG. 4.

FIG. 6 is a top view of the clip of the first embodiment.

FIG. 7 is a schematic view showing the clip of the first embodiment in use.

FIG. 8 is a schematic view of the clip according to a second embodiment.

FIG. 9 is a schematic view showing part of the clip of the second embodiment.

FIG. 10 is an exploded view of FIG. 8.

Labels in the drawings represent as follows:
clip 100;
first metal arm 101;
second metal arm 102;
elastic member 103;
hinged hole 104;
sleeve 110;
first sleeve element 111;
first ring 1111;
first cylinder 1112;
second sleeve element 112;
second ring 1121;
second cylinder 1122;
through hole 113;
fixing device 120;
first connecting member 121;
connecting part 1211;
locking part 1212;
disassembly rod 122;
offsetting pivot 1221;
handle 1222;
second connecting member 123;
disassembly member 124;
disassembly wing 1241;
terminal 130;
gasket 140;
ordinary screw 150;
charger 200;
storage battery 300; and
adapter 400.

### DETAILED DESCRIPTION OF EMBODIMENTS

In order to have a better understanding of the technical characteristics, aims and effects of the present invention, the aim and effect, embodiments will be described in detail with reference to the drawings.

### The First Embodiment

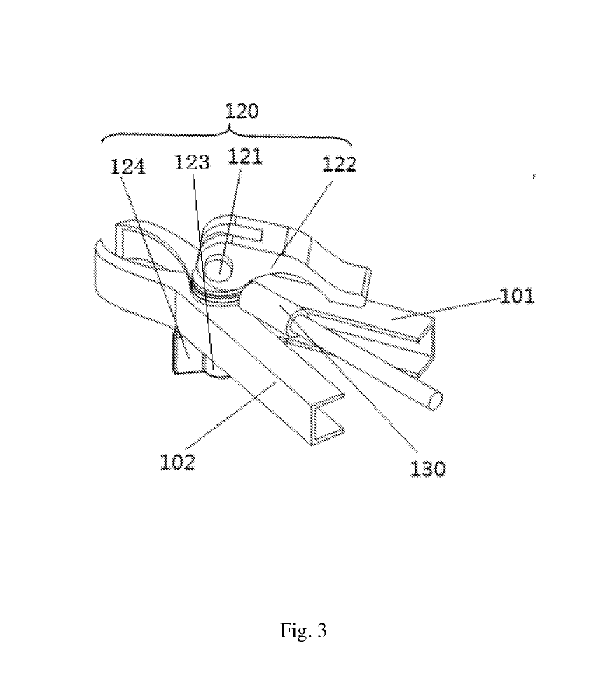

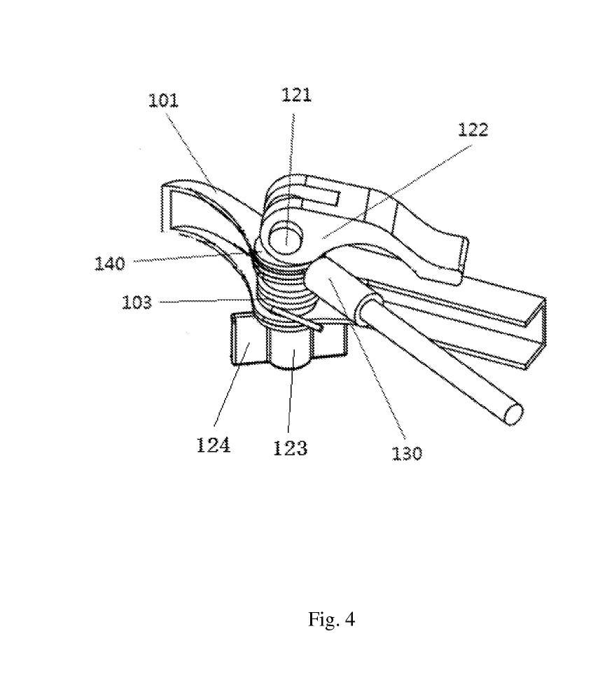

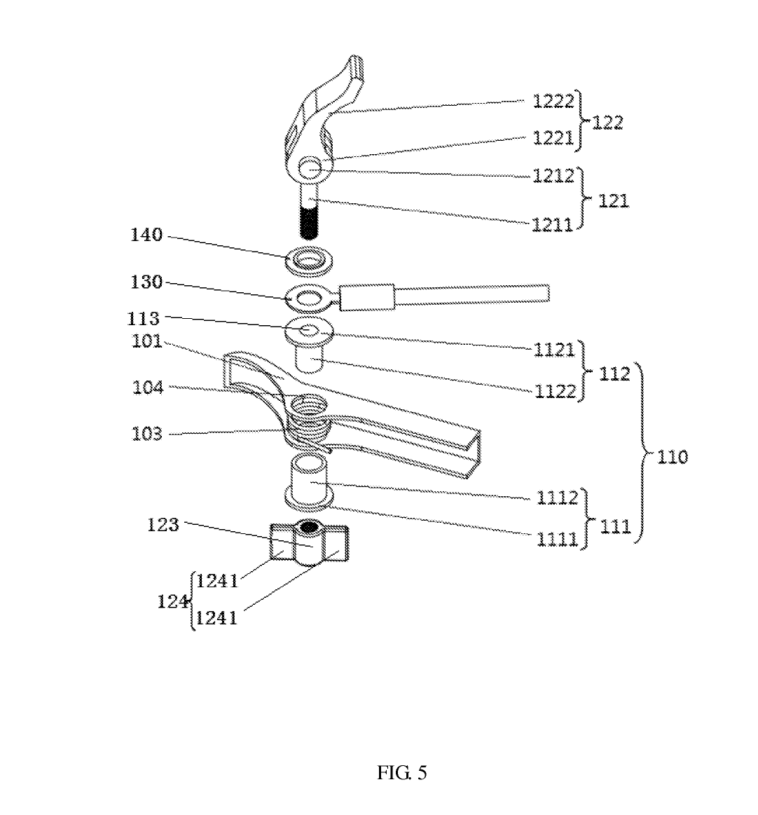

FIGS. 3-6 show a clip 100 of connecting wire according to a first embodiment. As shown in FIG. 4 and FIG. 5, the clip 100 includes a first metal arm 101 and a second metal arm 102 hinged to the first metal arm 101. A hinged portion of the first metal arm 101 and the second metal arm 102 is provided with an elastic member 103 cooperating with the first metal arm 101 and the second metal arm 102. The first metal arm 101, and the second metal arm 102 define a hinging hole 104. A sleeve 110 is provided in the hinging hole 104 and a fixing device 120 extending through the sleeve 110 for hinging the first metal arm 101, the second metal arm 102, and the elastic member 103. In detail, the sleeve 110 defines a smooth through hole 113 therein. The fixing device 120 includes a first connecting member 121 extending through the through hole 113, a disassembling rod formed on the first connecting member 121, a second connecting member 123 screwed on the first connecting member 121, and a disassembly member 124 provided on the first connecting member 121 or the second connecting member 123 for assembly or disassembly the first connecting member 121 and the second connecting member 123 rapidly. A movable terminal 130 is formed between the first connecting member 121 and the second terminal 130 for connecting the clip 100. The disassembly member 124 makes assembly or disassembly of the terminal 130 and the clip 100 need not auxiliary tools, which is convenient in use. In this embodiment, the disassembly member 124 includes two disassembly wings 1241 integrally formed with the second connecting member 123 to cooperatively form a butterfly nut.

The movable terminal 130 formed between the first connecting member 121 and the second terminal 130 for connecting the clip 100 makes the terminal 130 can be used to connect different types of clips 100, thereby charging different types of storage batteries, thus charging of the storage battery 300 is convenient, and needs not dedicated clip or terminal.

In this embodiment, the sleeve 110 is provided in the hinged hole between the first metal arm 101 and the second metal arm 102 with smooth through hole 113, and the fixing device 120 extends through the fixing device 120, which can avoid wear of internal of the clip 100 and frequently replacing of the clip 100 in the way of using ordinary screw 150 to assembly or disassembly the terminal 130 and the clip 100, which is in favor of saving costs of charging of the storage batteries of the household equipments.

As shown in FIG. 4 and FIG. 5, the elastic member 103 is mounted in the first metal arm 101 and the second metal arm 102 and surrounds the sleeve 110, cooperates with the first metal arm 101 and the second metal arm 102 to clasp the storage battery 300 of the car, motor, motorcycle, or other household equipment, and connects the charger 200 by the terminal 130, thereby charging the storage battery 300. As shown in FIG. 5, the elastic member 103 includes threaded part surrounding the sleeve 110 and two supporting parts extending from two ends of the threaded part to abut against the first metal arm 101 and the second metal arm 102, respectively. It can be understood that the elastic member 103 is made of metal.

As shown in FIG. 5, the first connecting member 121 includes a connecting part 1211 extending through the through hole 113, a locking part 1212 integrally formed with the connecting part 1211, and the disassembling rod mounted on the locking part 1212 offsetly for assembling or disassembling the terminal 130 and the clip 100. An end of the connecting part 1211 away from the locking part 1212 forms external threads matching with the second connecting member 123. It can be understood that, the connecting part 1211 extends through the through hole 113 of the sleeve 110, a part of the connecting part 1211 in the through hole 113 can be smooth or with threads. The end of the connecting part 1211 away from the locking part 1212 has external threads matching with the second connecting member 123, which makes the second connecting member 123 be screwed with the external threads of the connecting part 1211, and makes the terminal 130 be fixed on the first connecting member 121. An internal of the sleeve 110 is smooth, thus operation of extending of the connecting part 1211 through the sleeve 110 is simple and convenient, and damage and replacing of clip 100 for wear of the connecting part 1211 and the internal of the sleeve 110 is avoided.

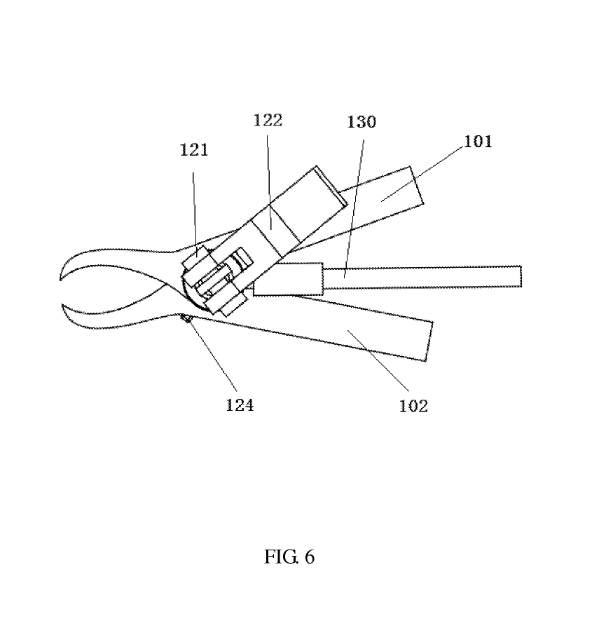

In detail, the disassembly rod 122 includes an offsetting pivot 1221 fixed on the locking part 1212 and an arc-shaped handle 1222 integrally formed with the offsetting pivot 1221. When the handle 1222 is pull up, the terminal 130 and the clip 100 are unfix, and when the handle 1222 is press down, the terminal 130 and the clip 100 are fixed. A distance of a portion of the offsetting pivot 1221 between the locking part 1212 and the terminal 130 in the state of unfix is less than that of a potion of the offsetting pivot 1221 between the locking part 1212 and the terminal 130 in the fixed state, thus makes connection of terminal 130 and the clip 100 in the fixed state is tight. It can be understood that the locking part 1212 and the connecting part 1211 are integrally formed and are T-shaped, which is convenient for mounting the disassembly rod 122 quickly, as shown in FIG. 6.

In detail, the terminal 130 is arranged on the connecting part 1211 between the disassembly rod 122 and the sleeve 110, thus makes the terminal 130 be pressed on the clip 100 tightly when the handle 1222 is pressed down. It should be understood that a gasket is mounted on the connecting part 1211 between the terminal 130 and the disassembly rod 122, and the gasket can be plastic. The gasket can avoid wear between the disassembly rod 122 and the terminal 130 during using the disassembly rod 122 for pressing the terminal 130 on the clip 100. Furthermore, the gasket can avoid poor connect between the charger 200 connected to the terminal 130 and the storage battery 300 by the clip 100 for loosing of the disassembly rod 122 and the terminal 130.

As shown in FIG. 5, the sleeve 110 includes a first sleeve element 111 and a second sleeve element 112 corresponding to the first sleeve element 111, the first sleeve element 111 includes a first ring 1111 and a first cylinder 1112 perpendicular to the first ring 1111 and integrally formed with the first ring 1111. The second sleeve element 112 includes a second ring 1121 and a second cylinder 1122 perpendicular to the second ring 1121 and integrally formed with the second ring 1121. An inner diameter of the first cylinder 1112 is larger than that of the second cylinder 1122. It can be understood that an internal hole of the second cylinder 1122 is the through hole 113. When the clip 100 is assembled, the first metal arm 101, the second metal arm 102 and the elastic member 103 are mounted the first cylinder 1112 of the first sleeve element 111, and then the second cylinder 1122 of the second sleeve element 112 is inserted in the first cylinder 1112. The first ring 1111, and the second ring 1121 are used to avoid falling off of the first metal arm 101, the second metal arm 102, and the elastic member 103.

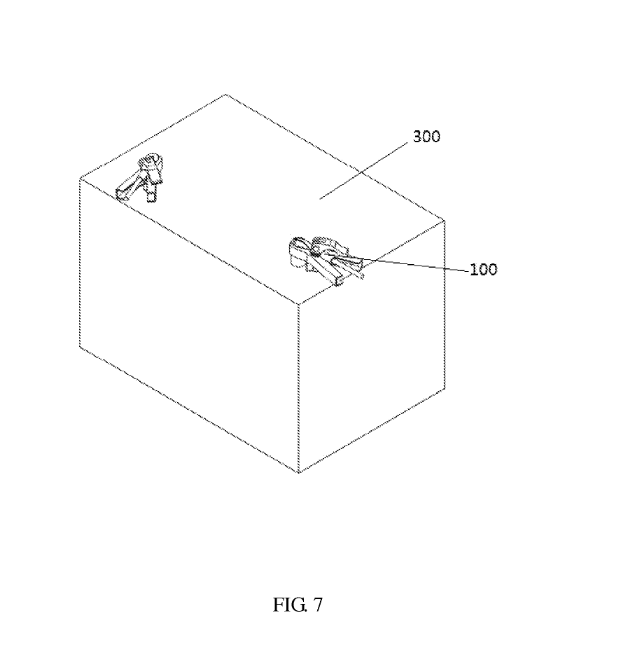

During connecting the clip 100 and the terminal 130, as shown in FIG. 5, the connecting part 1211 of the first connecting member 121 extends through the gasket, the terminal 130, and the second sleeve element 112 and the first sleeve element 111 of the sleeve 110 in turn, and the second connecting member 123 is screwed with the external threads of the connecting part 1211, thereby fixing the terminal 130 onto the clip 100. During operation, as shown in FIG. 7, the clip 100 is fixed on the storage battery 300 of household equipment, and the handle 1222 of the disassembly rod 122 of the first connecting member 121 is pressed down, thus the terminal 130 is pressed on the storage battery 300 tightly to charge the storage battery 300.

### The Second Embodiment

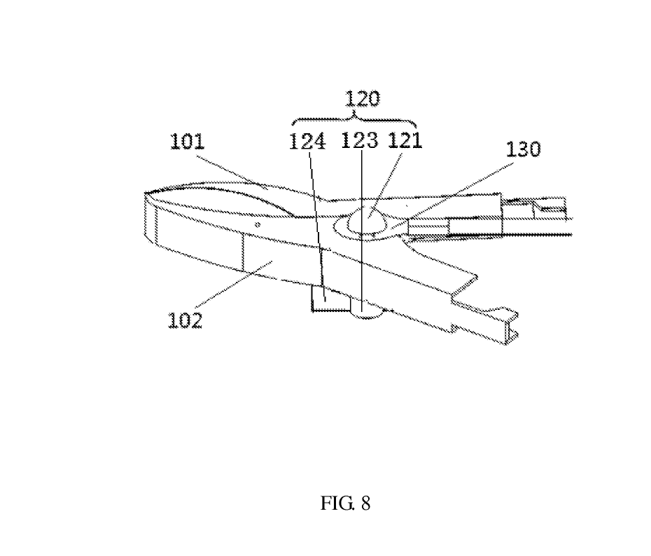

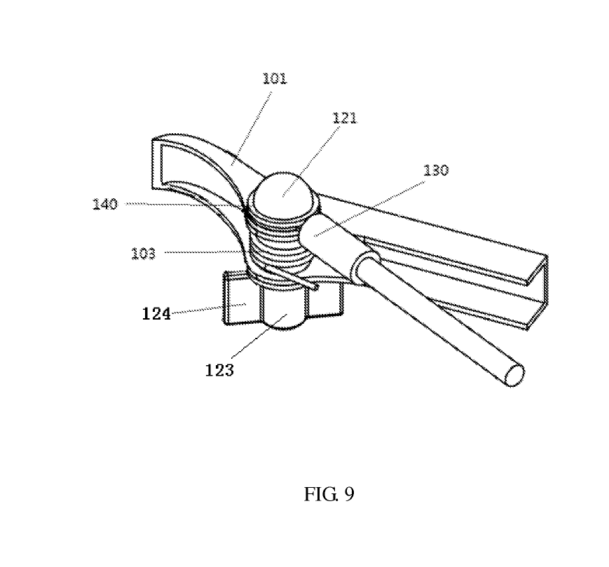

FIGS. 8-10 show a clip 100 of connecting wire according to a second embodiment. The clip 100 includes a first metal arm 101 and a second metal arm 102. A hinged portion of the first metal arm 101 and the second metal arm 102 is provided with an elastic member 103 cooperating with the first metal arm 101 and the second metal arm 102. The first metal arm 101, and the second metal arm 102 each define a hinging hole 104. A sleeve 110 is provided in the hinging hole 104 and a fixing device 120 extending through the sleeve 110 for hinging the first metal arm 101, the second metal arm 102, and the elastic member 103. In detail, the sleeve 110 defines a smooth through hole 113 therein. The fixing device 120 includes a first connecting member 121 extending through the through hole 113, a second connecting member 123 screwed on the first connecting member 121, and a disassembly member 124 provided on the first connecting member 121 or the second connecting member 123 for assembly or disassembly the first connecting member 121 and the second connecting member 123 rapidly. A movable terminal 130 is formed between the first connecting member 121 and the second terminal 130 for connecting the clip 100. The disassembly member 124 makes assembly or disassembly of the terminal 130 and the clip 100 need not auxiliary tools, which is convenient in use.

The movable terminal 130 formed between the first connecting member 121 and the second terminal 130 for connecting the clip 100 makes the terminal 130 can be used to connect different types of clips 100, thereby charging different types of storage batteries, thus charging of the storage battery 300 is convenient, and needs not dedicated clip 100 or terminal 130.

In this embodiment, the sleeve 110 is provided in the hinged hole between the first metal arm 101 and the second metal arm 102 with smooth through hole 113, and the fixing device 120 extends through the fixing device 120, which can avoid wear of internal of the clip 100 and frequently replacing of the clip 100 in the way of using ordinary screw 150 to assembly or disassembly the terminal 130 and the clip 100, which is in favor of saving costs of charging of the storage batteries of the household equipments.

In this embodiment, the first connecting member 121 includes a connecting part 1211 and a locking part 1212 integrally formed with the connecting part 1211. An end of the connecting part 1211 away from the locking part 1212 forms external threads matching with the second connecting member 123. It can be understood that, the connecting part 1211 extends through the through hole 113 of the sleeve 110, a part of the connecting part 1211 in the through hole 113 can be smooth or with threads. The end of the connecting part 1211 away from the locking part 1212 has external threads matching with the second connecting member 123, which makes the second connecting member 123 be screwed with the external threads of the connecting part 1211, and makes the terminal 130 be fixed on the first connecting member 121. An internal of the sleeve 110 is smooth, thus operation of extending of the connecting part 1211 through the sleeve 110 is simple and convenient, and damage and replacing of clip 100 for wear of the connecting part 1211 and the internal of the sleeve 110 is avoided.

In this embodiment, the disassembly member 124 includes two disassembly wings 1241 integrally formed with the second connecting member 123 and opposite to each other. The disassembly member 124 and the second connecting member 123 are integral and cooperatively form a butterfly nut, which is convenient for assembly or disassembly the first connecting member 121 and the second connecting member 123. The locking part 1212 defines a recess having a shape of “+”, “−” or “*”, thereby screwdriver or other like tools can be used to assemble or disassembly the first connecting member 121 and the second connecting member 123. It can be understood that the disassembly member 124 further can have two disassembly wings 1241 integrally formed with the first connecting member 121 and opposite to each other. That is, the disassembly member 124 and the first connecting member 121 are integral and cooperatively form a butterfly nut.

The terminal 130 is arranged on the connecting part 1211 between the locking part 1212 and the sleeve 110, and a gasket is arranged between the locking part 1212 and the terminal 130. Alternatively, the terminal 130 is arranged on the connecting part 1211 between the second connecting member 123 and the sleeve 110, and the gasket is arranged between the second connecting member 123 and the terminal 130. It to be understood that the gasket is for avoiding wear between the locking part 1212 and the terminal 130, or the second connecting member 123 and the terminal 130, and for avoiding unchargeable of the charger 200 to the storage battery 300 for loosing of the terminal 130 and the clip 100.

It should be understood that the elastic member 103, the sleeve 110, etc. are the same with those in the first embodiment.

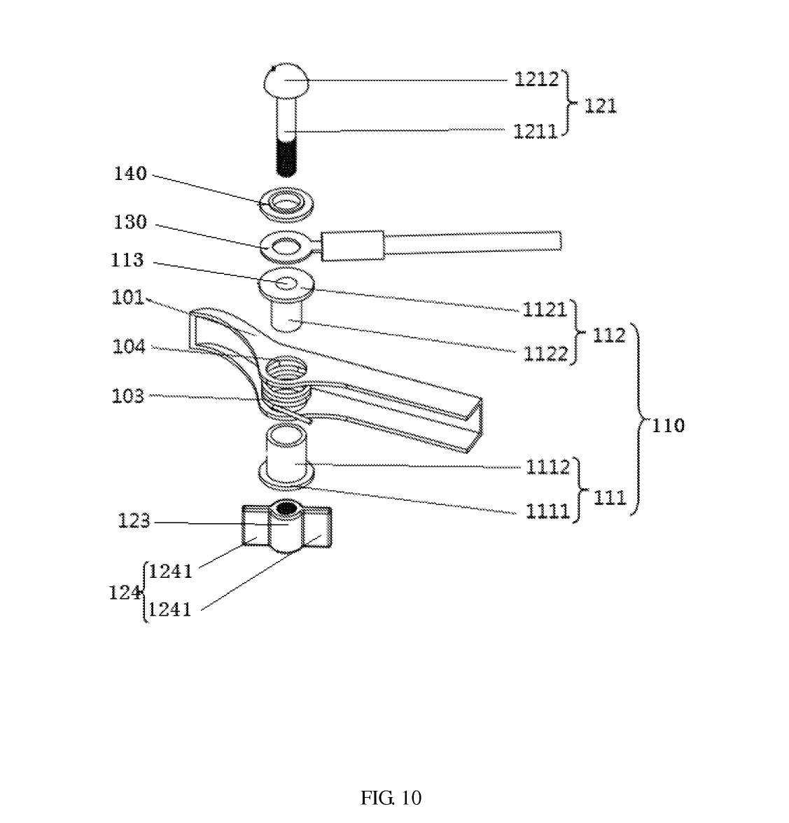

During connecting the clip 100 and the terminal 130, as shown in FIG. 10, the connecting part 1211 of the first connecting member 121 extends through the gasket, the terminal 130, and the second cylinder 1122 of the second sleeve element 112 and the first cylinder 1112 of the first sleeve element 111 of the clip 100 in turn, and the second connecting member 123 is screwed with the external threads of the connecting part 1211, thereby fixing the terminal 130 onto the clip 100. Alternatively, the connecting part 1211 of the first connecting member 121 extends through the first cylinder 1112 of the first sleeve element 111, the terminal 130, and the gasket in turn, and the second connecting member 123 is screwed with the external threads of the connecting part 1211 to fix the terminal 130 onto the clip 100. During operation, the clip 100 connected to the terminal 130 is fixed on the storage battery 300 of household equipment, thus the charger 200 connected to the terminal 130 charges the storage battery 300.

The foregoing is considered to be illustrative of the principles of the present invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A clip of connecting wire, comprising:
a first metal arm;
a second metal arm hinged with the first metal arm;
an elastic member arranged on a hinged portion of the first metal arm and the second metal arm is provided;
wherein the first metal arm and the second metal arm define a hinged hole, a sleeve is provided in the hinging hole for connecting the first metal arm, the second metal arm and the elastic member, the sleeve defining a smooth through hole therein, a fixing device extending through the through hole, the fixing device comprising a first connecting member extending through the through hole, a second connecting member screwed on the first connecting member, and a disassembly member provided on one of the first connecting member and the second connecting member, a movable terminal being formed between the first connecting member and the second terminal for connecting the clip.

2. The clip of claim 1, wherein the first connecting member comprises a connecting part extending through the through hole, a locking part integrally formed with the connecting part, and a disassembling rod mounted on the locking part offsetly for assembling or disassembling the terminal and the clip, an end of the connecting part away from the locking part forming external threads matching with the second connecting member, an external diameter of the locking part being larger than a diameter of the through hole.

3. The clip of claim 2, wherein the disassembly rod comprises an offsetting pivot fixed on the locking part and an arc-shaped handle integrally formed with the offsetting pivot, when the handle is pull up, the terminal and the clip are unfix, and when the handle is press down, the terminal and the clip are fixed, and a distance of a portion of the offsetting pivot between the locking part and the terminal in the state of unfix is less than that of a potion of the offsetting pivot between the locking part and the terminal in the fixed state.

4. The clip of claim 2, wherein the disassembly member comprises two disassembly wings integrally formed with the second connecting member.

5. The clip of claim 2, wherein the terminal is arranged on the connecting part between the disassembly rod and the sleeve, and a gasket is mounted on the connecting part between the terminal and the disassembly rod.

6. The clip of claim 1, wherein the first connecting member comprises a connecting part and a locking part integrally formed with the connecting part, an end of the connecting part away from the locking part forming external threads matching with the second connecting member.

7. The clip of claim 6, wherein the terminal is arranged on the connecting part between the locking part rod and the sleeve or is arranged on the connecting part between the second connecting member and the sleeve, and a gasket is mounted on the connecting part between the terminal and the locking part or between the terminal and the second connecting member.

8. The clip of claim 6, wherein the disassembly member comprises two disassembly wings integrally formed with the first connecting member and opposite to each other.

9. The clip of claim 6, wherein the disassembly member comprises two disassembly wings integrally formed with the second connecting member and opposite to each other, and the locking part defines a recess having one of shapes of “+” “−” and “*”.

10. The clip of claim 1, wherein the sleeve comprises a first sleeve element and a second sleeve element corresponding to the first sleeve element, the first sleeve element comprising a first ring and a first cylinder perpendicular to the first ring and integrally formed with the first ring, the second sleeve element comprising a second ring and a second cylinder perpendicular to the second ring and integrally formed with the second ring, an inner diameter of the first cylinder being larger than that of the second cylinder, the second cylinder defining the through hole.
